(19) United States
(12) Patent Application Publication
(10) Pub. No.: US 2009/0312057 A1
(43) Pub. Date: Dec. 17, 2009

(54) RECONFIGURABLE BASE STATION ANTENNA

(76) Inventors: Young-Chan MOON, Suwon-si (KR); Sung-Hwan Soh, Hwaseong-si (KR); In-Ho Kim, Yongin-si (KR)

Correspondence Address: CHA & REITER, LLC, 210 ROUTE 4 EAST STE 103, PARAMUS, NJ, 07652, US

(21) Appl. No.: 12/484,379

(22) Filed: Jun. 15, 2009

Related U.S. Application Data
(60) Provisional application No. 61/061,681, filed on Jun. 16, 2008.

(30) Foreign Application Priority Data
Jun. 3, 2009 (KR) 10-2009-0049138

(51) Int. Cl. H04M 1/00

(52) U.S. Cl. 455/562.1

(57) ABSTRACT

A reconfigurable base station (BS) antenna permits increasing cell capacity by dynamically varying an antenna's configuration according to a wave propagation environment and subscriber distribution. At least two reflective plates each have at least one radiator, a ray dome accommodates the two reflective plates in a hollow interior, and upper and lower caps are combined with upper and lower portions of the ray dome, respectively. Reflective connection members are connected to the respective two reflective plates and the upper and lower caps, so that the two reflective plates are rotatable, and at least one force generator provides a rotation force, and at least one force transfer mechanical portion transfers the rotation force received from the force generator to at least one reflective plate and controls a rotation angle of the at least one reflective plate. At least one of the force generator and the force transfer mechanical portion is combined with the two reflective plates.

### CLAIMS OF PRIORITY

This application claims priority from an application entitled “Reconfigurable Base Station Antenna” filed in the Korean Intellectual Property Office on Jun. 3, 2009 and assigned Serial No. 10-2009-0049138, and the contents of which are hereby incorporated by reference in its entirety, and this application claims priority from U.S. provisional application 61/061,681, filed Jun. 16, 2008, the contents of which are hereby incorporated by reference in its entirety.

### BACKGROUND OF THE INVENTION

1. Field of the Invention

The present invention generally relates to a Base Station (BS) antenna. More particularly, the present invention relates to a BS antenna supporting a multiple antenna scheme and increased transmission capacity in wireless communications.

2. Description of the Related Art

Along with the development of mobile communication technology, the advent of 4^{th} Generation (4G) networks are expected to begin operations long before 3^{rd} Generation (3G) networks become saturated. Major international standards for 4G networks, Mobile WiMAX or Long Term Evolution (LTE) are seeking to maximize a data rate per frequency band, i.e. increase capacity (bps/Hz) based on multiple antenna technologies. Among them, a multiple antenna technology called Multiple-Input Multiple-Output (MIMO) is currently used to improve capacity most effectively.

For a BS antenna, while the multiple antenna technology is based on baseband signal processing, an increase in capacity by use of multiple antennas may vary with antenna configuration. Because the multiple antenna technology cancels interference from other subscribers, actively utilizing multi-path fading, the capacity improvement effects are different according to the wave propagation environment and subscriber distribution of an area serviced by a particular BS. In this context, international standards allow free antenna installation according to a field situation rather than define antenna configurations.

Conventionally, however, antenna beams are fixed. Hence, once antennas are installed, capacity improvement is sought for only relying on baseband signal processing without adaptation to the wave propagation environment and subscriber distribution. Although the antennas themselves or the antenna configuration can be changed on a tower when needed, this task takes much time, energy and cost to change and optimize the antennas for a particular environment, which is not a static environment. Moreover, it is difficult to cope with changes of the wave propagation environment and subscriber distribution over time. That is, the conventional technology has limitations in areas such as load balancing, as well as reflecting the communication environment in real time, and there is no specific technique used for steering antenna beams to hot spots.

### SUMMARY OF THE INVENTION

An aspect of the exemplary embodiments of the present invention is to provide a BS antenna for varying the radiation directions of antenna beams in a remote location according to a wave propagation environment and a subscriber distribution.

Another aspect of the present invention is to provide a BS antenna for increasing cell capacity by dynamically changing an antenna configuration according to a wave propagation environment and a subscriber distribution.

A further aspect of the present invention provides a BS antenna for balancing load by reflecting a communication environment in real time and steering antenna beams to hot spots.

In accordance with still another aspect of the present invention, there is provided a BS antenna, in which at least two reflective plates each have at least one radiator, a ray dome accommodates the at least two reflective plates in a hollow interior, upper and lower caps are combined with upper and lower portions of the ray dome, respectively, reflective connection members are connected to the at least two reflective plates and the upper and lower caps, so that the at least two reflective plates are rotatable, at least one force generator provides a rotation force, and at least one force transfer mechanical portion transfers the rotation force received from the force generator to at least one reflective plate and controls a rotation angle of the at least one reflective plate. At least one of the force generator and the force transfer mechanical portion is combined with the at least two reflective plates.

### BRIEF DESCRIPTION OF THE DRAWINGS

The above and other exemplary objects, features and advantages of the present invention will become more apparent from the following detailed description taken in conjunction with the accompanying drawings, in which:

FIG. 1A illustrates an antenna installation structure according to a first multiple antenna technology-supporting scheme;

FIG. 1B is an exemplary view illustrating the patterns and directions of beams radiated from the antenna illustrated in FIG. 1A;

FIG. 2A illustrates an antenna installation structure according to a second multiple antenna technology-supporting scheme;

FIG. 2B is an exemplary view illustrating the patterns and directions of beams radiated from the antenna illustrated in FIG. 2A;

FIG. 3A illustrates an antenna installation structure according to a third multiple antenna technology-supporting scheme;

FIG. 3B is an exemplary view illustrating the patterns and directions of beams radiated from the antenna illustrated in FIG. 3A;

FIG. 4 is a perspective view of a BS antenna according to an exemplary embodiment of the present invention;

FIGS. 5A to 5E are exemplary views illustrating the beam patterns and directions of beams radiated from the BS antenna illustrated in FIG. 4;

FIG. 6 is a perspective view of a BS antenna according to another exemplary embodiment of the present invention; and

FIGS. 7A to 7E are exemplary views illustrating the beam patterns and directions of beams radiated from the BS antenna illustrated in FIG. 6.

Throughout the drawings, the same drawing reference numerals will be understood to refer to the same elements, features and structures.

### DETAILED DESCRIPTION

The matters defined in the exemplary descriptions hereinbelow, such as a detailed construction and elements, are provided for illustrative purposes to assist in a comprehensive understanding of exemplary embodiments of the reconfigurable base station antenna according to the present invention, and not to limit the invention to the exemplary embodiments shown and described. Accordingly, those of ordinary skill in the art will recognize that various changes and modifications of the exemplary embodiments described herein can be made without departing from the spirit of the invention and the scope of the appended claims. Also, descriptions of well-known functions and constructions may be omitted for clarity and conciseness.

Many costs are undertaken to build a new communication service network (e.g. a 4G network) while providing a mobile communication service over an existing communication service network (e.g. a 2G or 3G network). Transitioning between the existing communication service network (e.g. the 2G or 3G network) and the new communication service network (e.g. the 4G network) by co-siting may reduce the cost of installing the new communication service network. Hence, co-siting BSs are typically required for building the new communication service network. That is, an antenna for the future-generation communication service network should be added to a tower with an existing antenna.

Conventionally, a mobile communication BS uses a ±45-degree dual-polarization antenna to achieve polarization diversity. To support a 4-branch multiple antenna technology using the ±45-degree dual-polarization antenna, the following three methods are available. The first method includes spacing two dual-polarization antennas sufficiently from each other to achieve spatial diversity (referred to as a first scheme). The second method includes configuring a quad-polarization antenna by use of two neighboring dual-polarization antennas within a single ray dome (referred to as a second scheme). The method includes forming two antenna beams that are steered at different angles using neighboring dual-polarization antennas and a Butler Matrix.

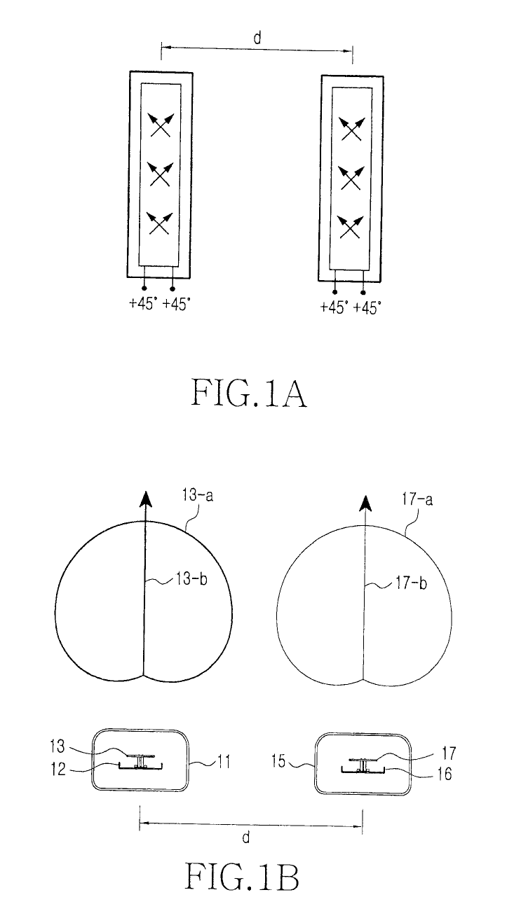

FIG. 1A illustrates an antenna installation structure according to the first multiple antenna technology-supporting scheme and FIG. 1B is an exemplary view illustrating the patterns and directions of beams radiated from the antenna illustrated in FIG. 1A. Referring to FIGS. 1A and 1B, two reflective plates, a first reflective plate 12 having a plurality of radiators 12 and a second reflective plate 16 having a plurality of radiators 17 are mounted on two ray domes 11 and 15, respectively. The two ray domes 11 and 15 are spaced from each other by a predetermined distance d. Thus, the first reflective plate 12 radiates a beam 13-a of a first pattern toward a first direction 13-b, and the second reflective plate 16 apart from the first reflective plate 12 by the predetermined distance radiates a beam 17-a of a second pattern toward a second direction 17-b. Despite the benefits of simultaneous polarization diversity and spatial diversity, this first scheme is not favorable in terms of antenna price, installation cost, tower space, and tower lease due to the requirement of two antennas.

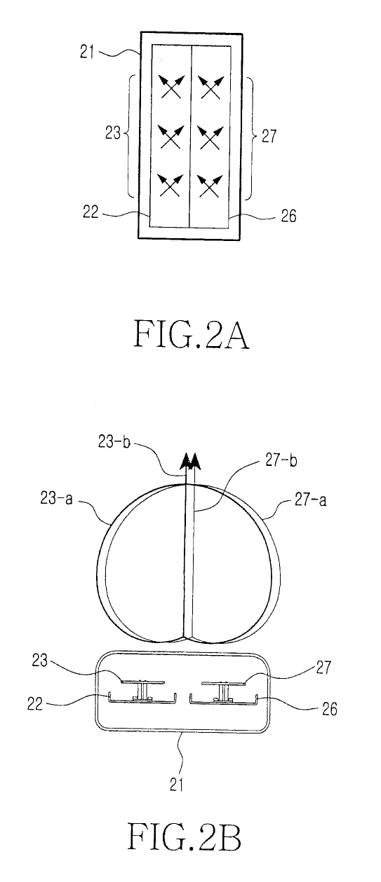

FIG. 2A illustrates an antenna installation structure according to the second multiple antenna technology-supporting scheme and FIG. 2B is an exemplary view illustrating the patterns and directions of beams radiated from the antenna illustrated in FIG. 2A. Referring to FIGS. 2A and 2B, two reflective plates, a first reflective plate 22 having a plurality of radiators 23 and a second reflective plate 26 having a plurality of radiators 27 are mounted alongside each other on a single ray dome 21. Thus, the first reflective plate 22 radiates a beam 23-a of a first pattern toward a first direction 23-b, and the second reflective plate 26 neighboring to the first reflective plate 22 radiates a beam 27-a of a second pattern toward a second direction 27-b. While the second scheme is cost-effective as compared to the first scheme, it has limitations in securing a sufficient capacity in the multiple antenna technology because of a large signal correlation between the two antennas.

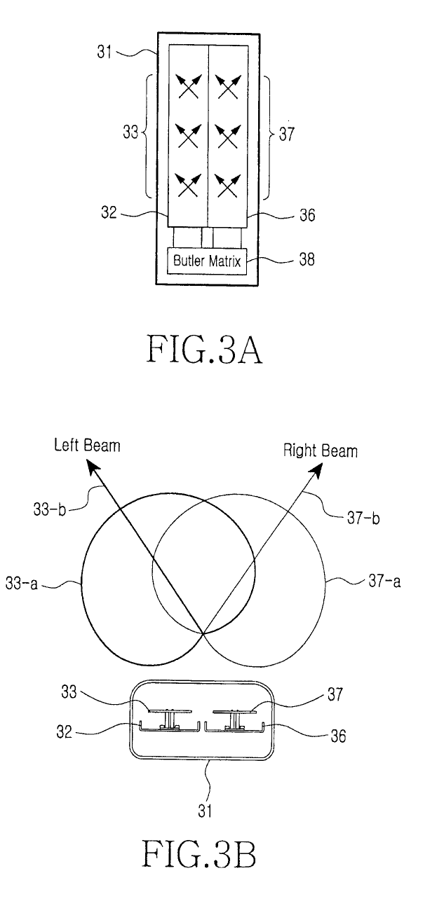

FIG. 3A illustrates an antenna installation structure according to the third multiple antenna technology-supporting scheme and FIG. 3B is an exemplary view illustrating the patterns and directions of beams radiated from the antenna illustrated in FIG. 3A. Referring to FIGS. 3A and 3B, two reflective plates, a first reflective plate 32 having a plurality of radiators 33 and a second reflective plate 36 having a plurality of radiators 37 are mounted alongside each other on a single ray dome 31 and the steering angles of antenna beams from the first and second reflective plates 32 and 36 are changed using a Butler matrix generated from a Butler matrix generator 38. Thus, the first reflective plate 32 radiates a beam 33-a of a first pattern toward a first direction 33-b, and the second reflective plate 36 neighboring to the first reflective plate 32 radiates a beam 37-a of a second pattern toward a second direction 37-b. This third scheme overcomes the signal correlation problem by pattern diversity, while taking cost effectiveness which is the advantage of the second antenna configuration. However, the use of the Butler matrix increases signal loss, antenna scan loss, and antenna complexity. When the steering angles of antenna beams are electrically differentiated by the Butler Matrix, the antenna patterns change according to frequency. Especially since transmission and reception frequencies are spaced much in Frequency Division Duplex (FDD), the deadly shortcoming that transmission and reception antenna beams are not tuned occurs.

The above-described three antenna schemes are common in fixed antenna beams, cannot adapt themselves to a wave propagation environment and a subscriber distribution, and should expect a capacity increase only relying on baseband signal processing once antennas are installed

As described in the description of FIGS. 1 through 3, the antenna schemes have fixed antenna beams, cannot adapt themselves to a wave propagation environment and a subscriber distribution, and should expect a capacity increase only relying on baseband signal processing once antennas are installed.

In contrast, the present invention provides a BS antenna for achieving a maximal capacity increase based on the multiple antenna technology by forming remote-controllable antenna beams and changing the antenna beams adaptively according to a wave propagation environment and a subscriber distribution, overcoming the problems encountered with using a Butler matrix, supporting a load balancing function by adjusting the directions of antenna beams according to the subscriber distribution, and steering the antenna beams to hot spots within a service area.

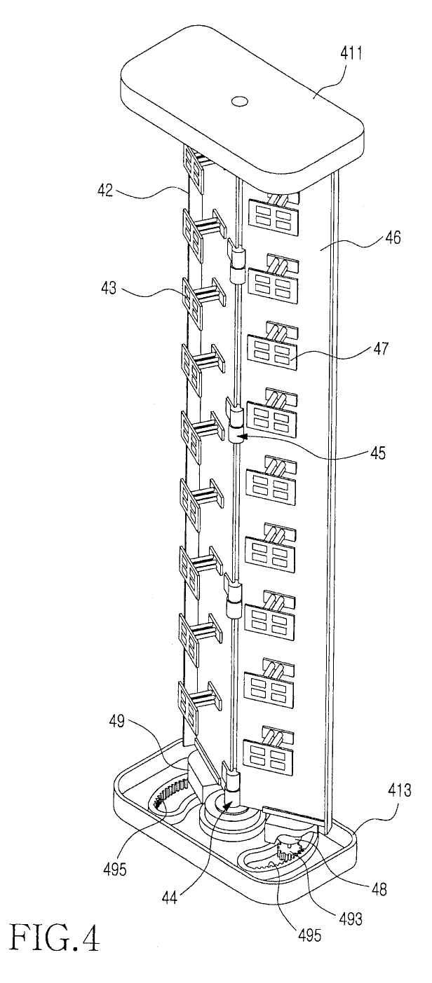

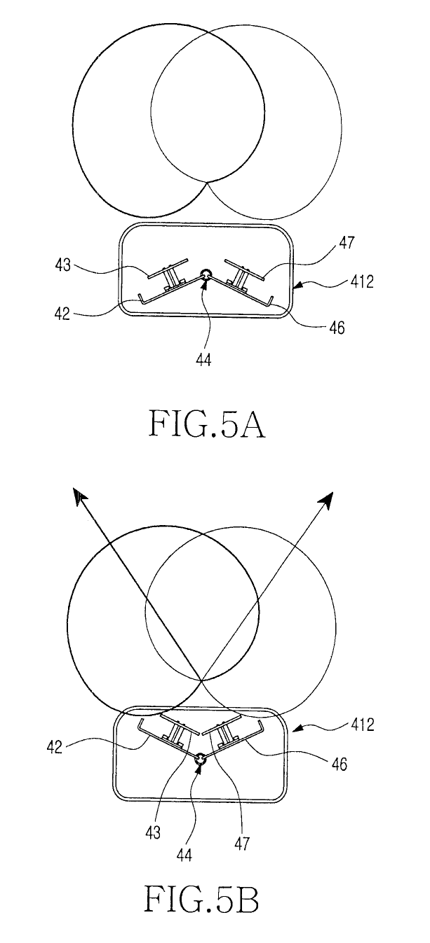

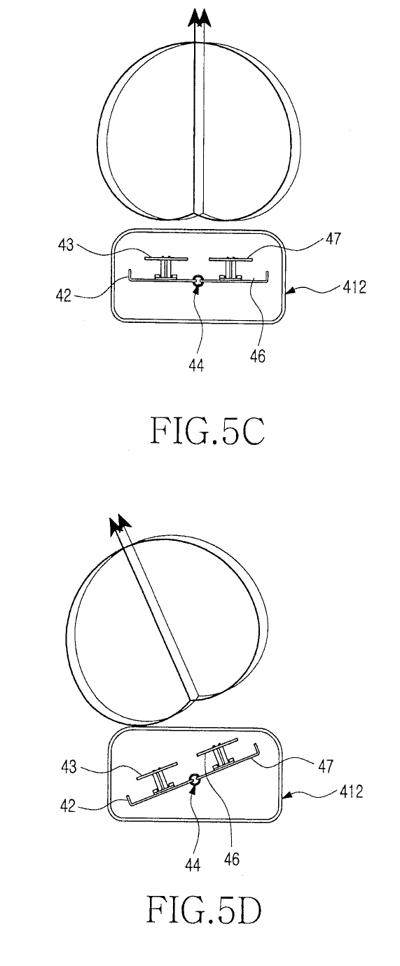

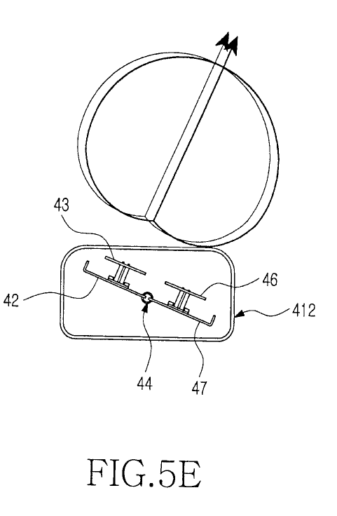

FIG. 4 is a perspective view of a reconfigurable BS antenna according to an exemplary embodiment of the present invention and FIGS. 5A to 5E are exemplary views illustrating the beam patterns and directions of beams radiated from the BS antenna such as illustrated in FIG. 4.

Referring now to FIGS. 4 to 5E, the exterior of the reconfigurable BS antenna according to an exemplary embodiment of the present invention is formed by a ray dome 412 attached with an upper cap 411 and a lower cap 413 at an upper portion and a lower portion thereof, respectively. A plurality of radiators 43 and 47, one or more reflective plates 42 and 46, and devices for fixing the radiators 43 and 47 and the reflective plates 42 and 46 are provided within the ray dome 412. In particular, the BS antenna according to the exemplary embodiment of the present invention includes reflective plate connection members 44 and 45 for rotatably fixing the radiators 43 and 47 and the reflective plates 42 and 46, and one or more force generators 48 and one or more force transfer mechanical portion for controlling the rotations of the reflective plates 42 and 46 from a remote location.

As shown in FIGS. 5A and 5B, the reflective plate connection members may comprise first and second hinges 44, 45, wherein first hinges 44 are fixed to the upper cap 411 and/or the lower cap 413 and second hinges 45 are installed between the reflective plates 42 and 46. The first and second hinges 44 and 45 are installed pivotably to and around center shafts, and may include mirror housings connected to the respective reflective plates 42 and 46. In particular, the center shaft of the first hinge 44 is fixed to the upper cap 411 and/or the lower cap 413. The structure of the reflective connection members provides a rotation axis upon the center shafts of the first and second hinges 44, 45 and enables the reflective plates 42 and 46 to rotate around the rotation axis.

The force generators 48 receive control signals from a remote location and generate force for the rotations of the reflective plates 42 and 46. For example, the force generators 48 may comprise, for example, electric motors.

The force transfer mechanical portion includes at least one external gear 493 and at least one internal gear 495 provided in the lower cap 413 along the movement path of the at least one external gear 493 formed by the rotations of the reflective plates 42 and 46. Owing to the structure of the force transfer mechanical portion, the BS antenna may receive a control signal for controlling the rotations of the reflective plates 42 and 46 from a remote location (e.g. a BS body). Also, the BS antenna may control the rotation angles of the reflective plates 42 and 46 by the operations of the force generators 48. Thus, the reflective plates 42 and 46 may rotate by the force generators 48, as illustrated in FIGS. 5A to 5E and the BS antenna of the present invention can support load balancing between sectors, steer antenna beams toward hot spots in a service area, and/or operate the sectors of a BS in various manners. Herein, at least one external gear 493 may be provided.

Each of the force transfer mechanical portion may further include an auxiliary cap 49 for accommodating a force generator 48 in a hollow hole inside the force transfer mechanical portion.

Further, the BS antenna may further include guide rails (not shown) between the upper cap 411 and the reflective plates 42 and 46, for compensating for vibrations of the reflective plates 42 and 46.

While the components of the force transfer mechanical portion is shown as devices for rotating the reflective plates 42 and 46 in the aforementioned exemplary embodiment of the present invention, the present invention is not limited thereto, as virtually any type of structure capable of controlling the rotations of the reflective plates 42 and 46 by means of a control signal received at the force generators 48 from a remote location suffices in the present invention.

Also, while the force transfer mechanical portion includes the at least one external gear 493 and the at least one internal gear 495 in the aforementioned exemplary embodiment of the present invention, the present invention is not limited thereto. Rather, a structure for controlling the rotations of the reflective plates 42 and 46 by means of a control signal received from a remote location suffices to the force transfer mechanical portion.

Although the force generators 48 and the external gear 493 are accommodated in the auxiliary caps 49 and the internal gear 495 are provided in the lower cap 413 in the exemplary embodiment of the present invention, it can be further contemplated that the force generators 48 can be affixed to the lower cap 413 and the at least one internal gear 495 are provided in the auxiliary caps 49.

In yet another exemplary embodiment of the present invention, the force generators 48 are installed at upper end portions of the reflective plates 42 and 46 and the at least one internal gear 495 are disposed between the force generators 48 and the upper cap 411.

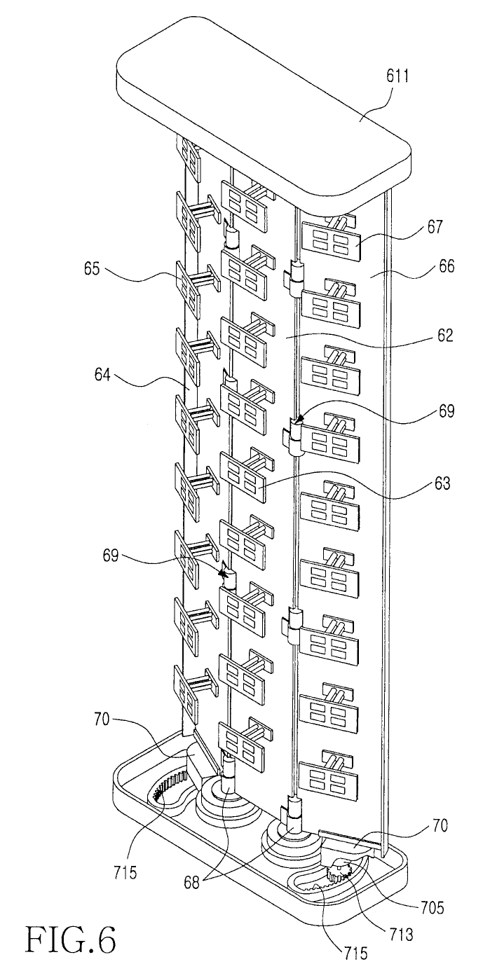

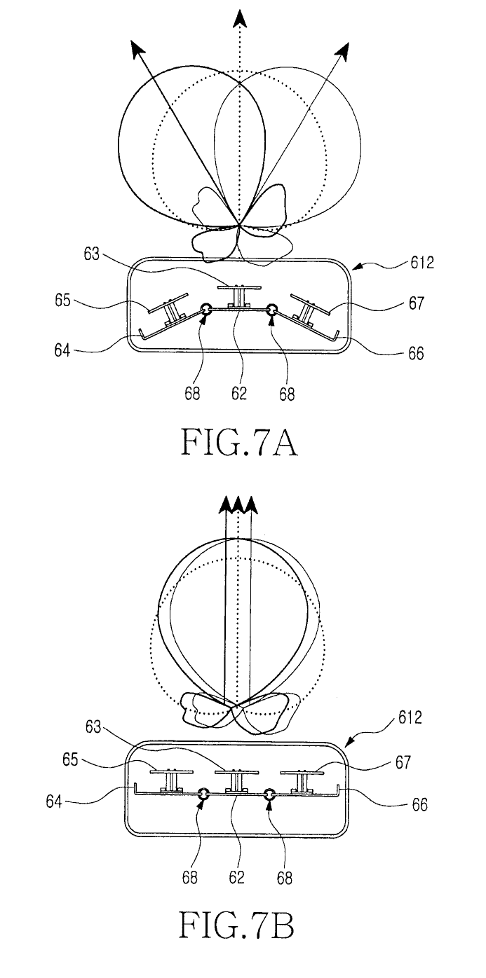

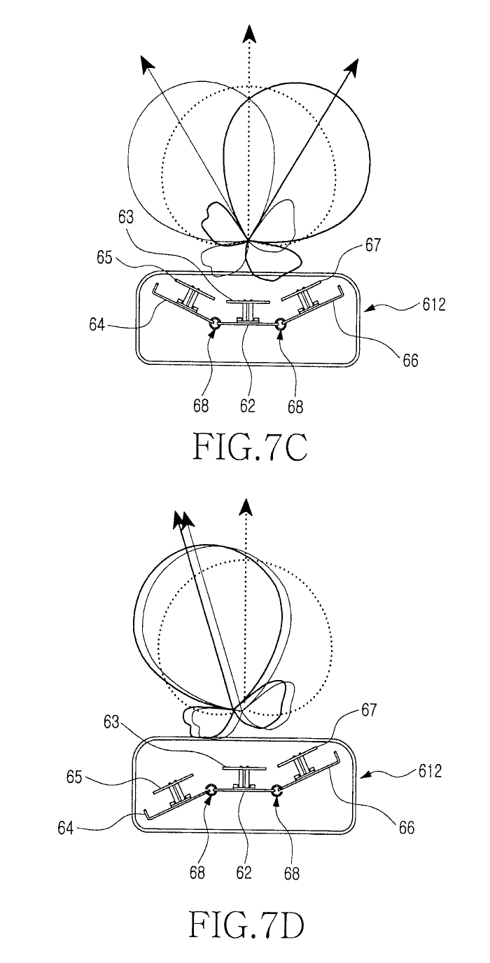

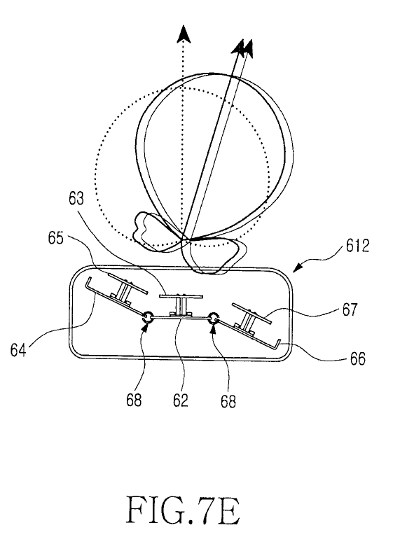

FIG. 6 is a perspective view of a BS antenna according to another (second) exemplary embodiment of the present invention, and FIGS. 7A to 7E are exemplary views illustrating the beam patterns and directions of beams radiated from a BS antenna such as in the example illustrated in FIG. 6.

The BS antenna according to the second exemplary embodiment of the present invention is virtually identical to the example shown according to the first exemplary embodiment of the present invention, in terms of configuration, except for the number of reflective plates 62, 64 and 66 in a ray dome 612 and devices used to rotate the reflective plates 62, 64 and 66.

To clarify the description of the reflective plates, the BS antenna according to the second exemplary embodiment of the present invention includes the three reflective antennas, that is, first, second and third reflective plates 62, 64 and 66 arranged about the ray dome 612. The second and third reflective plates 64, 66 are positioned on both sides of the first reflective plate 62. The second and third reflective plates 64, 66 are connected to the first reflective plate 62 by reflective plate connection members 68, 69. The reflective plate connection members 68 and 69 fix the position of the first reflective plate 62 and the second and third reflective plates 64 and 66 are rotatable around the central axis of the reflective plate connection members 68 and 69.

Also, force generators 705 and force transfer mechanical portion is provided to control the rotations of the second and third reflective plates 64, 66 from a remote location. As in the first exemplary embodiment of the present invention, each of the force transfer mechanical portion may includes at least one external gear 713 and at least one internal gear 715.

Furthermore, each of the transfer mechanical portion may further includes an auxiliary cap 70 for accommodating a force generator 705, and the auxiliary caps 70 may be installed to the second and third reflective plates 64, 66, respectively.

As shown in FIGS. 6-7E, owing to the structure of the force generators 705 and the force transfer mechanical portion, the BS antenna can receive a control signal for the force generators 705 from a remote location (including but not limited to, for example, a BS body) to control the rotations of the second and third reflective plates 64 and 66. The BS antenna can also control the rotation angles of the second and third reflective plates 64, 66 by the operations of the force generators 705. Thus, the second and third reflective plates 64, 66 may rotate by the force generators 705, as illustrated in FIGS. 7A to 7E. Consequently, signals for different communication services can be radiated simultaneously through the plurality of reflective plates 62, 64 and 66. For example, when a 2G (or 3G) communication service and a 4G communication service are provided concurrently, a signal for the 2G (or 3G) communication service may be radiated from the first reflective plate 62 and a signal for the 4G communication service may be radiated from the second and third reflective plates 64 and 66. Hence, the BS antenna according to the second exemplary embodiment of the present invention is very effective in building a new 4G network, while providing a 2G (or 3G) communication service. That is, since an existing 2G (3G) communication antenna is fixed at the center, and new 4G communication antennas are disposed on both sides of the existing communication antenna, signal correlation may be decreased to an appropriate level and an appropriate spatial diversity effect may result. In addition, as the radiation directions of antenna beams are mechanically controlled by the force generators 705 and the force transfer mechanical portion, pattern diversity may be achieved. Further, the BS antenna according to the second exemplary embodiment of the present invention may enable flexible operation of a co-siting BS through control of beam radiation directions, in spite of the structure a new communication network (e.g. a 4G communication network) being different from the structure of an existing communication network (e.g. a 3G communication network).

The multiple antenna technology may be evolved to Hybrid Multiple Antenna Technology (HMAT) that optimizes a mobile communication network by operating the BS antenna of the present invention in organic conjunction with a baseband signal processing technology. That is, signal processing takes place in baseband for individual subscribers and the BS antenna of the present invention is responsible for forming antenna beams according to a subscriber distribution, thereby optimizing the mobile communication network.

As is apparent from the above description, the BS antenna of the present invention has the following effects and provides at least the following advantages:

Since the steering angles of a plurality of reflective plates within a single ray dome is controlled from a remote location, load balancing is achieved by reflecting a communication environment in real time and antenna beams are steered to hot spots without temporal and spatial constraints.

A co-siting BS for simultaneously providing different services can be operated by use of the reflective plates within the single ray dome as antennas for different service networks.

An antenna configuration is changed adaptively according to a wave propagation environment and a subscriber distribution. Hence, cell capacity can be increased.

While the invention has been shown and described with reference to certain exemplary embodiments of the present invention thereof, it will be understood by those skilled in the art that various changes in form and details may be made therein without departing from the spirit of the present invention as defined by the scope of the appended claims and their equivalents.

What is claimed is:

1. A reconfigurable Base Station (BS) antenna comprising:
at least two reflective plates each having at least one radiator;
a ray dome for accommodating the at least two reflective plates in a hollow interior;
an upper cap combined with an upper portion of the ray dome and a lower cap combined with a lower portion of the ray dome;
reflective connection members connected to the at least two reflective plates and the upper and lower caps, respectively, so that the at least two reflective plates are rotatable;
at least one force generator for providing a rotation force; and
at least one force transfer mechanical portion for transferring the rotation force received from the force generator to at least one reflective plate and controlling a rotation angle of the at least one reflective plate,
wherein at least one of the force generator and the force transfer mechanical portion is combined with the at least two reflective plates.

2. The reconfigurable BS antenna according to claim 1, wherein the at least two reflective plates are dynamically reconfigurable according to a wave propagation environment and a subscriber distribution.

3. The reconfigurable BS antenna according to claim 1, wherein the at least two reflective plates are reconfigurable from a remote location according to a wave propagation environment and a subscriber distribution.

4. The reconfigurable BS antenna according to claim 1, wherein the at least two reflective plates provide a load balancing support function for adjusting the directions of antenna beams according to the subscriber distribution, and for steering antenna beams to hot spots within a service area.

5. The reconfigurable BS antenna of claim 1, wherein the force transfer mechanical portion includes at least one external gear coupled with a portion of the force generator and an internal gear coupled at the upper or lower cap along a movement radius of the at least one external gear.

6. The reconfigurable BS antenna of claim 1, wherein at least one of the force generator and the force transfer mechanical portion is combined with the upper or lower cap, and the force transfer mechanical portion includes an external gear coupled to a rotation axis of the force generator and an internal gear engaged with the external gear so that at least one reflective plate of the at least two reflective plates is rotatable.

7. The reconfigurable BS antenna of claim 1, wherein the upper cap is provided along movement radiuses of upper end portions of the reflective plates and includes a guide rail for vibration compensation of the at least two reflective plates.

8. The reconfigurable BS antenna of claim 1, wherein if the at least two reflective plates of the BS antenna comprises three reflective plates, a first reflective plate is arranged at a center position, and a second reflective plate and a third reflective plate are coupled respectively on opposite sides of the first reflective plate, the first reflective plate has a fixed beam radiation direction, and radiation angles of the second and third reflective plates are controlled by the force generator and the force transfer mechanical portion.

9. The reconfigurable BS antenna of claim 5, wherein if the at least two reflective plates of the BS antenna comprises three reflective plates, a first reflective plate is arranged at a center position, and a second reflective plate and a third reflective plate are coupled respectively on opposite sides of the first reflective plate, the first reflective plate has a fixed beam radiation direction, and radiation angles of the second and third reflective plates are controlled by the force generator and the force transfer mechanical portion.

10. The reconfigurable BS antenna of claim 6, wherein if the at least two reflective plates of the BS antenna comprises three reflective plates, a first reflective plate is arranged at a center position, and a second reflective plate and a third reflective plate are coupled respectively on opposite sides of the first reflective plate, the first reflective plate has a fixed beam radiation direction, and radiation angles of the second and third reflective plates are controlled by the force generator and the force transfer mechanical portion.

11. The reconfigurable BS antenna of claim 7, wherein if the at least two reflective plates of the BS antenna comprises three reflective plates, a first reflective plate is arranged at a center position, and a second reflective plate and a third reflective plate are coupled respectively on opposite sides of the first reflective plate, the first reflective plate has a fixed beam radiation direction, and radiation angles of the second and third reflective plates are controlled by the force generator and the force transfer mechanical portion.

12. The reconfigurable BS antenna according to claim 9, wherein one of a 2nd generation (2G) or a 3rd generation (3G) communication antenna is coupled to the first reflective plate, and 4th generation (4G) communication antennas are arranged on the second and third reflective plates on both sides of the first reflective plates.

13. The reconfigurable BS antenna according to claim 10, wherein one of a 2nd generation (2G) or a 3rd generation (3G) communication antenna is coupled to the first reflective plate, and 4th generation (4G) communication antennas are arranged on the second and third reflective plates on both sides of the first reflective plates.

14. The reconfigurable BS antenna according to claim 11, wherein one of a 2nd generation (2G) or a 3rd generation (3G) communication antenna is coupled to the first reflective plate, and 4th generation (4G) communication antennas are arranged on the second and third reflective plates on both sides of the first reflective plates.

15. The reconfigurable BS antenna according to claim 12, wherein one of a 2nd generation (2G) or a 3rd generation (3G) communication antenna is coupled to the first reflective plate, and 4th generation (4G) communication antennas are arranged on the second and third reflective plates on both sides of the first reflective plates.
